(19) United States
(12) Patent Application Publication
(10) Pub. No.: US 2012/0098960 A1
(43) Pub. Date: Apr. 26, 2012

(54) VIDEO COLLABORATION TYPE ILLUMINATING CONTROL SYSTEM AND VIDEO COLLABORATION TYPE ILLUMINATING CONTROL METHOD

(76) Inventors: Toshihiro Fujino, Osaka (JP); Yuichi Ishikawa, Hyogo (JP); Natsuki Saito, Osaka (JP)

(21) Appl. No.: 12/673,302

(22) PCT Filed: Aug. 26, 2008
(86) PCT No.: PCT/JP2008/002303

§ 371 Date: Feb. 12, 2010

(30) Foreign Application Priority Data
Aug. 31, 2007 (JP) 2007 225542

(51) Int. Cl. H04N 5/57; H05B 37/02; H04N 7/18

(52) U.S. Cl. 348/135; 348/687; 315/291; 348/E05.119; 348/E07.085

(57) ABSTRACT

A video link type illuminating control system and video link type illuminating control method allow a signal containing the idea of the content creator to be added to an airwave signal or a video content signal so that the audio-visual space is illuminated based on the control signal generated from the signal. As a result, illumination can be controlled in linkage with video, thus increasing visual realism.

### TECHNICAL FIELD

The present invention relates to a video link type illuminating control system and a video link type illuminating control method which control the lighting equipment arranged around the viewer according to the video being displayed, thereby delivering a greater sense of realism.

### BACKGROUND ART

New technologies have been developed in recent years to increase a sense of realism when viewing video such as TV shows and movies. In terms of audio quality in particular, a multi-channel surround system such as a 5.1 channel surround system allows the viewer to enjoy highly realistic video and audio at home.

In terms of video quality, on the other hand, various suggestions have been made to provide a sense of expanse when viewing the video. This is achieved by analyzing the colors of the video to be displayed and controlling the lighting equipment that illuminates the vicinity of the display. Patent Literature 1 below, for example, suggests providing a sense of broadness when viewing video content by calculating the average value of each color component either in the entire screen of the display or in each of a plurality of divided regions of the screen, and by illuminating the colors corresponding to the individual regions.

In some video being displayed, however, it is difficult to faithfully reproduce the state of light in the vicinity of the display only by the information of the video being displayed on the screen. For example, when there is an object in a dark space, and the object is displayed to fit the screen size, the surrounding area of the display should be dark, but it is actually illuminated with the color of the object, possibly resulting in being less realistic.

Such cases will be shown using FIGS. 12A, 12B, 13A, and 13B. FIGS. 12A and 12B show a first scene and a second scene, respectively. The first scene of FIG. 12A shows white cup 1203A placed on table 1202A in dark room 1201A. White cup 1203A is bright with a high luminance, and the remaining area is dark with a low luminance. The second scene of FIG. 12B shows a close-up of white cup 1203B placed on table 1202B in dark room 1201B. White cup 1203B is bright with a high luminance, and the remaining area is dark with a low luminance.

In the first scene of FIG. 12A, the detection of the average luminance of the entire screen indicates that the dark area is dominant, so that the lighting devices around the display are set to low illuminance. In this case, there is no problem because the contents of the display and the illuminance of the lighting devices agree with each other. In the second scene of FIG. 12B, on the other hand, the detection of the average luminance of the entire screen indicates that the bright area showing cup 1203B is dominant, so that this scene may be mistaken to be extremely bright (having a high average luminance level), and hence, the lighting devices around the display may be set to high illuminance.

As another case, FIGS. 13A and 13B show a third scene, and a fourth scene, respectively. The third scene of FIG. 13A is cloudy sky scene 1301A including clouds 1302A and is dark with low luminance as a whole. The fourth scene of FIG. 13B is cloudy sky scene 1301B including clouds 1302B and thunder 1313B which occupies an extremely small area of the screen. Thunder 1313B is bright with high luminance, and the remaining area is dark with low luminance.

In the third scene of FIG. 13A, the detection of the average luminance of the entire screen indicates that the dark area is dominant, so that the lighting devices around the display are set to low illuminance. In this case, there is no problem because the contents of the display and the illuminance of the peripheral devices agree with each other. In the fourth scene of FIG. 13B, on the other hand, the detection of the average luminance of the entire screen indicates that the dark area is still dominant, so that the lighting devices around the display are determined to be a dark scene (having a low average luminance level), and hence, the lighting devices around the display may be set to low illuminance. In a scene with thunder, by nature, the lighting devices around the display are preferably turned on and off in synchronization with the light of the thunder. Actually, however, an extremely small area of the screen may have too small an effect to properly perform the setup of the lighting devices.

Thus, in Patent Literature 1 as a conventional example, the setup of the lighting devices is based on the video signal contents displayed on the screen, possibly failing to fully express the idea intended by the content creator.

Another problem of Patent Literature 1 is that the contents displayed on the screen and the contents of the lighting devices do not agree with each other when the display of video on the screen and the emission of light from the lighting device are not performed at the timing intended by the content creator.

Thus, Patent Literature 1 as a conventional example does not consider the relationship between the timing at which the display unit displays a video signal and the timing at which the lighting devices emit light. As a result, when the lighting devices do not emit light at the same timing as the video due to the time required for processing the video signal, the idea of the content creator cannot fully be expressed.

Patent Literature 1: Japanese Patent Unexamined Publication No. 2005-251508

### SUMMARY OF THE INVENTION

In view of the conventional problems, it is an object of the present invention to provide a video link type illuminating control system and a video link type illuminating control method which faithfully reproduce the world that is intended to be expressed by the content creator, allowing the viewer to enjoy more realism.

A video link type illuminating control system includes a signal reading section for reading an optical information signal and a video signal from a video content; a video signal processing circuit for processing the video signal, and supplying a processed video signal to a display unit; an arithmetic circuit for calculating the timing or the intensity of the light emitted from a lighting unit based on the optical information signal, and generating an optical control signal; the lighting unit; and a transmission unit for transmitting the optical control signal generated by the arithmetic circuit to the lighting unit. The lighting unit receives the optical control signal from the transmission unit, and emits light in linkage with a video content displayed on the display unit.

The video link type illuminating control method includes a step for reading an optical information signal and a video signal from a video content; a step for processing the video signal and displaying video; a step for calculating the timing or the intensity of the light emitted from a lighting unit based on the optical information signal, and generating an optical control signal; a step for transmitting the optical control signal thus generated; and a step for receiving the optical control signal and emitting light in linkage with the video to be displayed.

### BRIEF DESCRIPTION OF THE DRAWINGS

FIG. 1 is a block diagram of a video link type illuminating control system according to the present invention.

FIG. 2 is a detailed block diagram of the video link type illuminating control system according to the present invention.

FIG. 3 shows an example of the relationship between the angle and the intensity of light of a predetermined color according to the present invention.

FIG. 4 shows the positional relationship between a viewer, a display unit, and lighting units.

FIG. 5 shows an example of sections expressed by the lighting units.

FIG. 6 is another block diagram of the video link type illuminating control system according to the present invention.

FIG. 7 is another detailed block diagram of the video link type illuminating control system according to the present invention.

FIG. 8 shows the transmission contents of a signal according to the present invention.

FIG. 9 is another block diagram of the video link type illuminating control system according to the present invention.

FIG. 10 is further another block diagram of the video link type illuminating control system according to the present invention.

FIG. 11A is a characteristic diagram of a lighting unit.

FIG. 11B is a characteristic diagram of another lighting unit.

FIG. 12A shows a process in a conventional video link type illuminating control system.

FIG. 12B shows another process in the conventional video link type illuminating control system.

FIG. 13A shows another process in the conventional video link type illuminating control system.

FIG. 13B shows another process in the conventional video link type illuminating control system.

### REFERENCE MARKS IN THE DRAWINGS

11 video content
12 signal reading section
13 video signal processing circuit
14 display unit
15 arithmetic circuit
16 transmission unit
17 lighting unit
21 intensity distribution averaging circuit
22 control signal hold circuit
23 control signal readout circuit
100 video link type illuminating control system
900 video link type illuminating control system
911 video content
912 signal reading section
913 video signal processing circuit
914 display unit
915 arithmetic circuit
916 transmission unit
917 lighting unit
921 display control unit
922 optical sensor
1000 video link type illuminating control system
1001 camera

### DETAILED DESCRIPTION OF PREFERRED EMBODIMENTS

### First Exemplary Embodiment

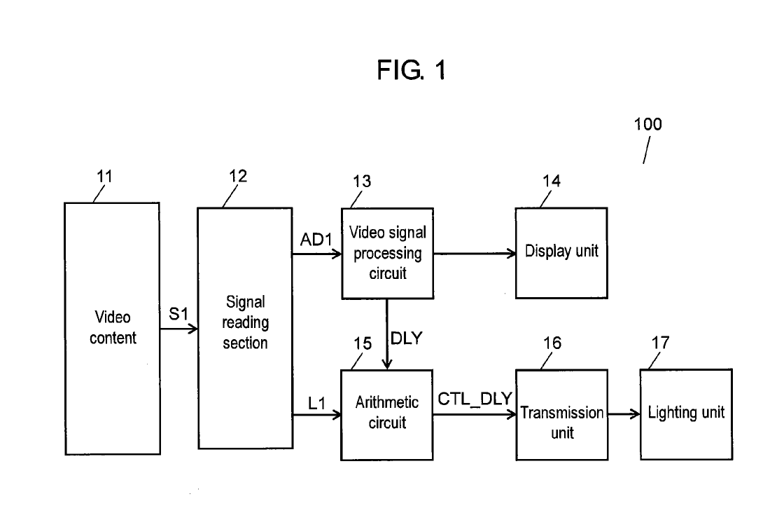

A first exemplary embodiment according to the present invention will be described as follows with reference to FIGS. 1 to 5.

FIG. 1 is a block diagram of a video link type illuminating control system according to the present invention. In FIG. 1, video link type illuminating control system 100 includes video content 11, signal reading section 12, video signal processing circuit 13, display unit 14, arithmetic circuit 15, transmission unit 16, and lighting unit 17.

Video content 11 includes, in addition to a video signal and an audio signal that are conventionally included in a video content, an optical information signal indicating the position and the intensity of a light source for illuminating audio-visual space. Video content 11 can be received from a broadcast channel or a network, or reproduced from a storage medium or memory.

Signal reading section 12 reads signal S1 from video content 11, and provides video signal processing unit 13 with video signal AD1, and arithmetic unit 15 with optical information signal L1.

Video signal processing unit 13 indicates all signal processing circuits performing processes such as interlaced/progressive conversion and various image quality enhancement before displaying video on a display unit.

Display unit 14 can be a plasma display panel, a liquid crystal panel, or a cathode-ray tube display.

Arithmetic circuit 15 generates an optical control signal CTL_DLY from the position and intensity information of light contained in the optical information signal L1, and transmits it to transmission unit 16.

Transmission unit 16 transmits a signal corresponding to the received optical control signal CTL_DLY to lighting unit 17 either wired or wirelessly.

Lighting unit 17 is composed of a set of red, green, and blue lights and receives signals indicating the intensities of these colors, thereby producing various colors and illuminating the audio-visual space. The direction of the arrangement and the number of lighting unit 17 can be arbitrarily set by registering them beforehand in arithmetic circuit 15.

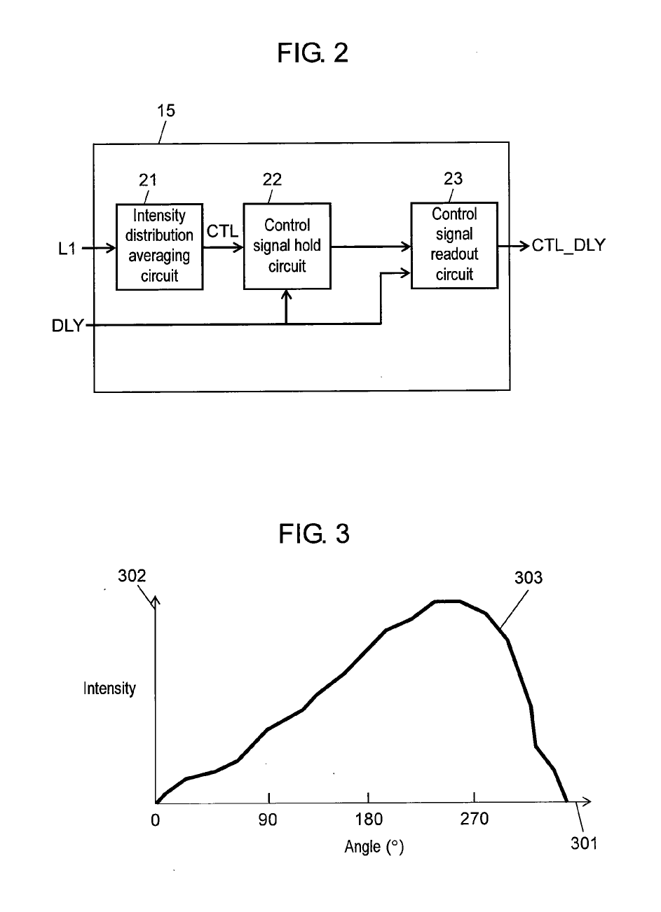

A specific structure of arithmetic circuit 15 is described as follows. FIG. 2 shows a detailed structure of arithmetic circuit 15 of FIG. 1. As shown in FIG. 2, arithmetic circuit 15 includes intensity distribution averaging circuit 21, control signal hold circuit 22, and control signal readout circuit 23. The optical information signal L1 received from signal reading section 12 contains information recorded in fields, indicating the intensities of the light of the three primary colors (RGB) and the angles of the light from the position of the viewer.

FIG. 3 is a graph showing the relationship between the angle and the intensity of light of a color of the optical information signal L1 in a certain field. FIG. 3 includes vertical axis 302 representing the intensity of the light emitted from lighting unit 17, horizontal axis 301 representing the angle indicating the position of lighting unit 17 for illuminating the audio-visual space, and graph 303 showing the relationship between the angle and the intensity.

Intensity distribution averaging circuit 21 registers therein information such as the angle and the number of lighting unit 17. Intensity distribution averaging circuit 21 calculates the amount of light emitted from each lighting unit 17 based on the above-mentioned information by averaging the intensities in the section of graph 303 of FIG. 3 in the charge of each lighting unit 17.

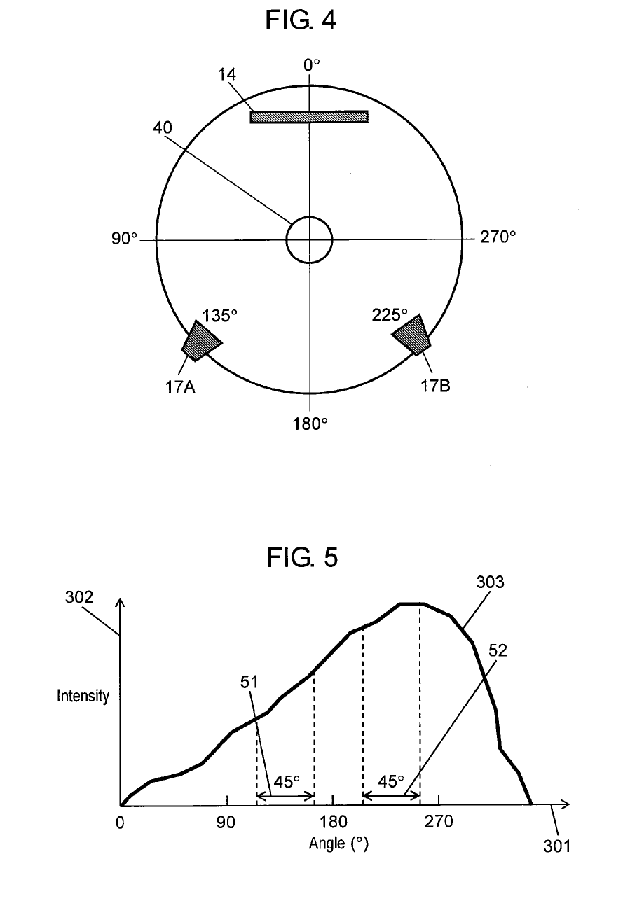

FIG. 4 shows an example in which two lighting units 17 are placed diagonally backward right and diagonally backward left of the viewer. FIG. 4 thus shows the positional relationship between viewer 40, display unit 14, and lighting units 17A and 17B composing lighting unit 17 of FIG. 1. Display unit 14 is placed in front of viewer 40, that is, at an angle of 0 degrees from viewer 40. Lighting unit 17A is diagonally backward left of viewer 40, that is, at an angle of 135 degrees from viewer 40. Lighting unit 17B is diagonally backward right of viewer 40, that is, at an angle of 225 degrees from viewer 40.

FIG. 5 shows the integral ranges within which intensity distribution averaging circuit 21 performs averaging, using lighting units 17A and 17B of FIG. 4. In FIG. 5, vertical axis 302, horizontal axis 301, and graph 303 are identical to those in FIG. 3. Integral range 51 for lighting unit 17B is integrated within 45 degrees around 135 degrees of graph 303. Integral range 52 for lighting unit 17A is integrated within 45 degrees around 225 degrees of graph 303. Thus, intensity distribution averaging circuit 21 generates and outputs an optical control signal CTL.

In this case, the integral range is 45 degrees, but arithmetic circuit 15 can previously determine the number of the lighting units, and the angle range to be integrated by each lighting unit according to the positional relationship.

Control signal hold circuit 22 holds the optical control signal CTL received from intensity distribution averaging circuit 21 for a certain period, and then transmits it to control signal readout circuit 23. The time after the video signal AD1 is processed by video signal processing circuit 13 and until it is displayed by display unit 14 is not necessarily the same as the time after arithmetic circuit 15 receives the optical information signal L1 and until lighting unit 17 emits light. Therefore, making lighting unit 17 emit light without considering the time lag may cause the light from lighting unit 17 not to be synchronized with the video on display unit 14, possibly reducing the realism.

To avoid this, control signal hold circuit 22 and control signal readout circuit 23 receive from video signal processing circuit 13 a delay time DLY representing the time required to display the video signal AD1 on display unit 14. Then, control signal hold circuit 22 holds the optical control signal CTL for a period of time corresponding to the time difference between the delay time DLY and the time required for lighting unit 17 to emit light, and then transmits the optical control signal CTL to control signal readout circuit 23. Control signal readout circuit 23 outputs the signal received from control signal hold circuit 22 as the optical control signal CTL_DLY at the timing related to the delay time DLY. Thus, the video on display unit 14 and the light from lighting unit 17 are controlled to be synchronized with each other.

Thus, according to the present invention, the setup of the lighting devices is based on the video signal contents displayed on display unit 14, fully expressing the idea intended by the content creator. Furthermore, according to the present invention, the display of video on display unit 14 and the emission of light from the lighting devices can be performed at the timing intended by the content creator, so that the contents displayed on the screen and the contents of the lighting devices can agree with each other.

### Second Exemplary Embodiment

A second exemplary embodiment will describe the structure of the first exemplary embodiment in greater detail. The second exemplary embodiment is compliant with the HDMI standard, but the present invention is not limited to this standard. The second exemplary embodiment shows an example in which HDMI Source 600 transmits a video signal and a control signal to HDMI Sink 650 via HDMI 680, and then HDMI Sink 650 transmits the control signal (optical information signal) to the above-mentioned lighting unit. HDMI Source 600 can be a STB (Set Top Box), and HDMI Sink 650 can be a TV (television receiver). The present invention, however, is not limited to this: HDMI Source 600 can be replaced by video and control signals, which can be received from a broadcasting station either wired or wirelessly, recorded in a storage medium or memory, or obtained from a network.

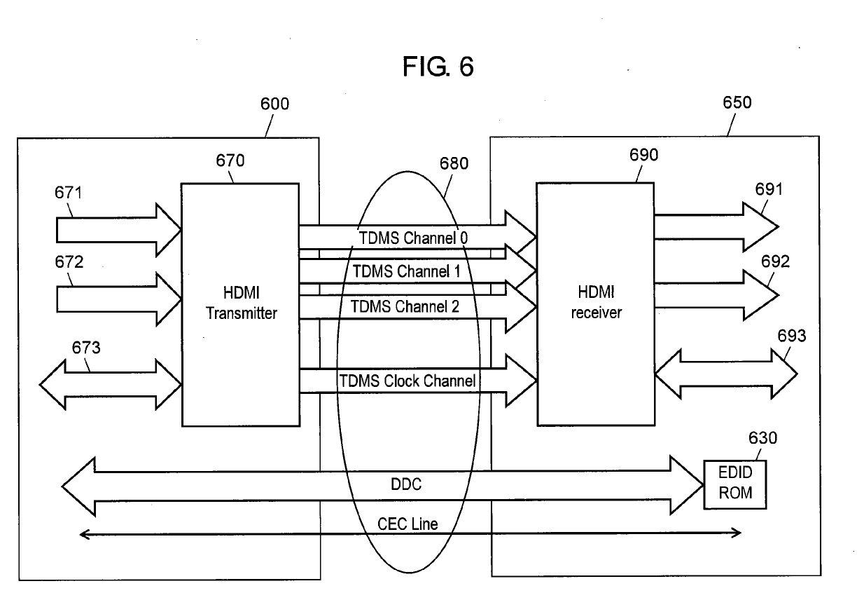

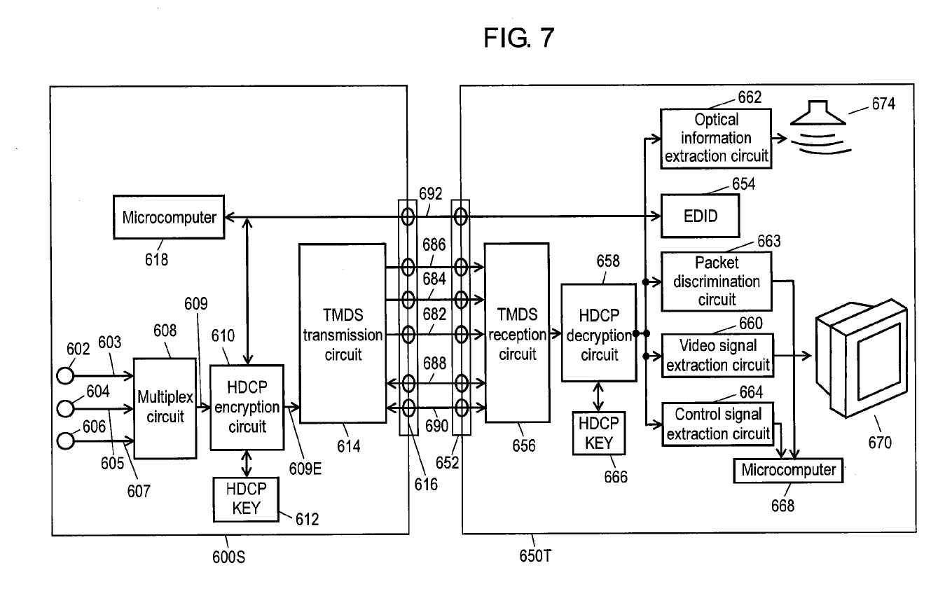

A structure to achieve the present invention will be described as follows with reference to FIGS. 6 to 8. FIGS. 6 and 7 are block diagrams of HDMI Source 600 and HDMI Sink 650 compliant with the HDMI standard. HDMI Source 600 and HDMI Sink 650 are connected to each other via TMDS (Transition Minimized Differential Signaling) channels 0 to 2, TMDS Clock Channel, and DDC (Display Data Channel) line (hereinafter, DDC Line). As shown in FIG. 7, HDMI cable 680 includes four differential signal lines 682, 684, 686, and 688. Three differential signal lines 682, 684, and 686 transmit TMDS data, and one differential signal line 688 transmits clock information. Three differential signal lines 682, 684, and 686 of FIG. 7 correspond to TDMS Channels 0, 1, and 2, respectively, of FIG. 6. Differential signal line 688 of FIG. 7 corresponds to a TDMS Clock of FIG. 6. These differential signal lines 682, 684, and 688 transmit video, audio, and control signals (auxiliary data). Note that although not illustrated, HDMI Source 600 and HDMI Sink 650 can communicated with each other wirelessly instead of using HDMI cable 680.

Differential signal line 688 for transmitting a TDMS Clock as the clock information carries a video signal clock, which is used to process the data transmitted on TMDS Channels 0 to 2 through the above-mentioned three differential signal lines 682 to 686. HDMI Source 600 and HDMI Sink 650 are further connected to each other via differential signal line 690, which corresponds to the DDC of FIG. 6. Differential signal line 690 allows HDMI Source 600 and HDMI Sink 650 to exchange information about their structures and states. As shown in FIG. 7, HDMI Source 600 and HDMI Sink 650 are further connected to each other via differential signal line 692 corresponding to the CEC Line of FIG. 6, achieving advanced control function between different kinds of video/audio devices in the user environment.

The structure of HDMI Source 600 and HDMI Sink 650 compliant with the HDMI standard of FIG. 6 will be described as follows with reference to FIG. 7.

FIG. 7 shows an example in which HDMI Source 600 is HDMI STB 600S, and HDMI Sink 650 is HDMI TV 650T. First, HDMI STB 600S will be described as follows. In HDMI STB 600S, terminal 602 receives an RGB video signal and audio signal 603, terminal 604 receives optical information signal 605, and terminal 606 receives control signal 607. These signals are transmitted to multiplex circuit 608. Multiplex circuit 608 compresses along time axis the audio signal, optical information signal 605, and control signal 607, and then inserts these signals into a video blanking period containing no video signal. These signals are combined with the RGB video signal, thereby generating multiplex signal 609.

Next, HDCP encryption circuit 610 encrypts multiplex signal 609 to put copy guard on it. In order to perform the encryption, HDCP encryption circuit 610 receives a key signal from HDCPKEY 612 according to the need, and outputs encrypted multiplex signal 609 E to TMDS transmission circuit 614. In TMDS transmission circuit 614, multiplex signal 609 E is converted to a 10-bit signal, TMDS encoded into a differential serial signal, and outputted through HDMI connection terminal 616. Differential signal line 682 corresponds to TDMS Channel 0 of FIG. 6 and carries a B signal (Blue signal). Differential signal line 684 corresponds to TDMS Channel 1 of FIG. 6 and carries a G signal (Green). Differential signal line 686 corresponds to TDMS Channel 2 of FIG. 6 and carries an R signal (Red). Differential signal line 688 corresponds to the TDMS Clock Channel of FIG. 6 and carries a Clock. During a video blanking period containing no video signal, optical information signal 605 and other signals are transmitted. Optical information signal 605 is divided into information signals for R, G, and B signals. The optical information signal 605 for the R signal can be superimposed during the video blanking period of Channel 0 through differential signal line 682. The optical information signal 605 for the B signal can be superimposed during the video blanking period of Channel 1 through differential signal line 684. The optical information signal 605 for the G signal can be superimposed during the video blanking period of Channel 2 through differential signal line 686. The audio signal and control signal 607 are also superimposed during the video blanking period.

The HDCP key information and EDID information are transmitted and received between HDMI connection terminals 616 and 652 via the I2C bus of differential signal line 690. EDID 654 is a storage device such as a ROM for storing EDID information including a signal format suitable for the display. The EDID information is read by microcomputer 618 of HDMI STB 600S according to the need. More specifically, microcomputer 618 detects that HDMI STB 600S has been connected to HDMI TV 650T, and reads the EDID information stored in EDID 654.

The following is a detailed description of HDMI TV 650T. In HDMI TV 650T, three (RGB) signals and one clock signal are received by TMDS reception circuit 656. The three (RGB) signals are paralleled, TMDS decoded, converted from a 10-bit signal to an 8-bit signal, and then restored to an 8-bit RGB video signal. The restored 8-bit RGB video signal is decrypted by HDCP decryption circuit 658, and transmitted to each of video signal extraction circuit 660, optical information signal extraction circuit 662, control signal extraction circuit 664, and packet discrimination circuit 663. HDCP decryption circuit 658 receives key information from HDCPKEY 666 in response to the key information received from HDMI STB 6005 and transmits the information to HDMI STB 600S. HDMI STB 600S verifies the key information and decrypts it.

Control signal extraction circuit 664 extracts control signal 607 superimposed during the video blanking period, and transmits extracted control signal 607 to microcomputer 668. Packet discrimination circuit 663 transmits the results of packet discrimination to microcomputer 668. Video signal extraction circuit 660 transmits a RGB video signal to TV display unit 670. Although not illustrated, it is possible to provide an OSD adding circuit or the like and to control the circuit by a microcomputer so as to add an OSD signal to the RGB video signal.

Next, optical information signal extraction circuit 662 extracts optical information signal 605 superimposed during the video blanking period, and outputs the extracted optical information signal 605 to illumination output unit 674. Illumination output unit 674 corresponds to lighting unit 17 of FIG. 1. In the second exemplary embodiment, optical information signal 605 and control signal 607 are described separately for easier explanation; however the present invention is not limited to this, and optical information signal 605 can be a part of control signal 607.

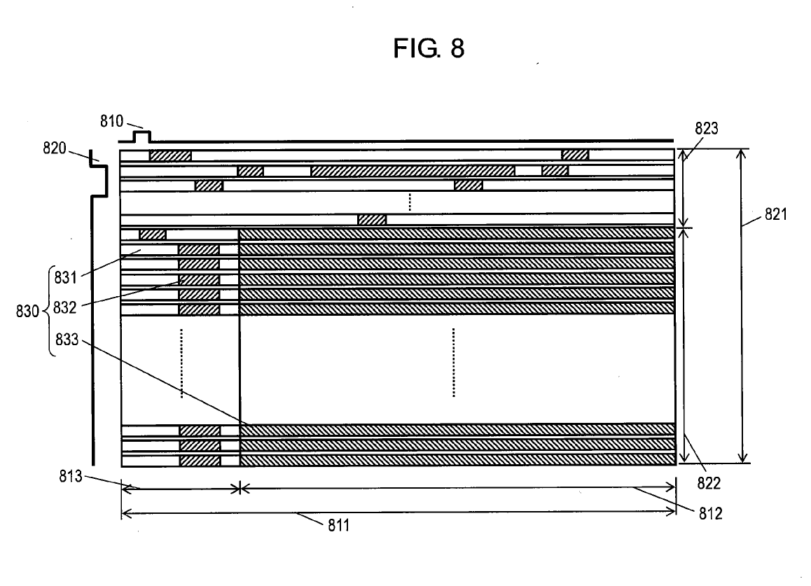

The following is a description of the structure of an HDMI-compliant signal. FIG. 8 shows an SD screen having the following structure. The screen includes horizontal scanning period 811 consisting of 858 pixels, and vertical scanning period 821 consisting of 525 lines. The effective area of the screen includes horizontal effective period 812 consisting of 720 pixels, and vertical effective period 822 consisting of 480 lines. The screen includes horizontal blanking period 813 including the period of horizontal synchronizing signal 810, and vertical blanking period 823 including the period of vertical synchronizing signal 820. Horizontal and vertical blanking periods 813 and 823 are collectively referred to as a video blanking period. The screen is formed of white areas in frames, areas hatched with upward sloping lines in frames, and areas hatched with down sloping lines in frames. The white areas in frames represent Control Period 831, and the areas hatched with upward sloping lines in frames represent Data island Period 832. The areas hatched with down sloping lines in frames represent Video Data Period 833. Control Period 831, Data island Period 832, and Video Data Period 833 together form TMDS Period 830. During Data island Period 832, Packet data is transmitted. The Packet data includes optical information signal 605 in addition to an Audio sample (the sampling information of the audio signal), Info frame (information contained in a signal), and the like.

Thus, optical information signal 605 is transmitted using Data island Period 832, which is in the video blanking period. As described above, control signal 607 and optical information signal 605 are described separately for easier explanation in the second exemplary embodiment. When optical information signal 605 is made a part of control signal 607, however, optical information signal 605 can be inserted into Control Period 831.

Optical information extraction circuit 662 in HDMI TV 650T extracts optical information signal 605 inserted into either Data island Period 832 or Control Period 831 of the video blanking period, and then transmits the extracted optical information signal 605 to lighting unit 674. This allows lighting unit 674 to reproduce optical information signal 605 indicating the idea of the content creator.

In HDMI TV 650T, the following timings are set in advance: the timing at which video is outputted to TV display unit 670 in accordance with the information from HDCP decryption circuit 658 via video signal extraction circuit 660, and the timing at which lighting unit 674 emits light in accordance with the information from HDCP decryption circuit 658 via optical information extraction circuit 662. As a result, the timing at which video is outputted from TV display unit 670 and the timing at which lighting unit 674 is turned on agree with each other. This allows the display of video on the screen and the emission of light from the lighting devices to be performed at the timing intended by the content creator.

More specifically, assume a case where the timing at which lighting unit 674 is turned on in accordance with the information from optical information extraction circuit 662 is later than the timing at which a video signal is displayed on TV display unit 670 in accordance with the information from video signal extraction circuit 660. In that case, it is possible to provide a buffer between video signal extraction circuit 660 and TV display unit 670 and to read a video signal from the buffer at the same timing as the timing at which lighting unit 674 is turned on. This structure can eliminate the delay time. Assume the opposite case where the timing at which video is displayed on TV display unit 670 in accordance with the information from video signal extraction circuit 660 is later than the timing at which lighting unit 674 is turned on in accordance with the information from optical information extraction circuit 662. In that case, it is possible to provide a buffer between optical information extraction circuit 662 and lighting unit 674 so as to eliminate the delay time.

### Third Exemplary Embodiment

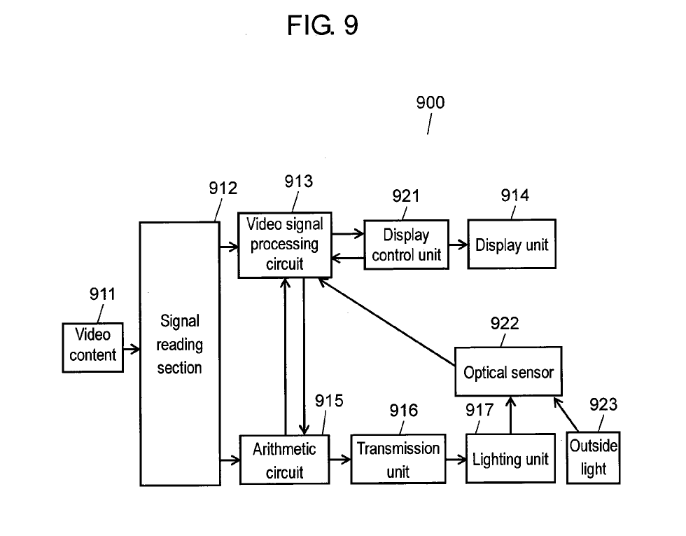

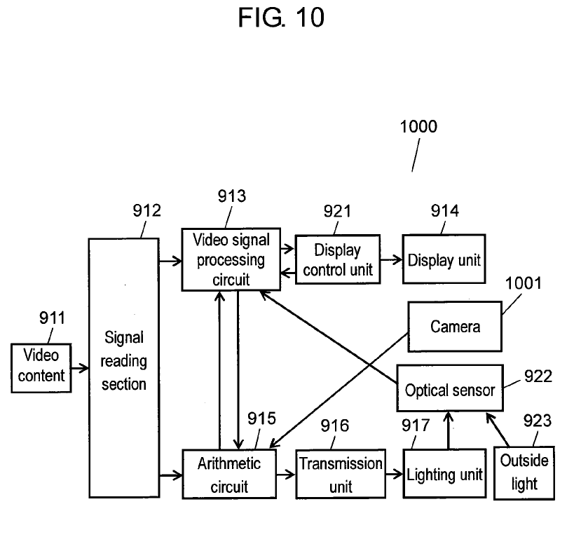

A third exemplary embodiment of the present invention will be described as follows with reference to FIGS. 9 and 10. FIG. 9 is a block diagram of a video link type illuminating control system according to the third exemplary embodiment.

In FIG. 9, video link type illuminating control system 900 includes video content 911, signal reading section 912, video signal processing circuit 913, display control unit 921, display unit 914, arithmetic circuit 915, transmission unit 916, lighting unit 917, optical sensor 922, and outside light 923. Video content 911, signal reading section 912, video signal processing circuit 913, display unit 914, arithmetic circuit 915, transmission unit 916, and lighting unit 917 are identical to video content 11, signal reading section 12, video signal processing circuit 13, display unit 14, arithmetic circuit 15, transmission unit 16, and lighting unit 17, respectively, shown in FIGS. 1 and 2, and hence the description thereof will be omitted. System 900 of FIG. 9 differs from system 100 of FIGS. 1 and 2 in having display control unit 921, optical sensor 922, and outside light 923. Therefore, the following description will be focused on display control unit 921, optical sensor 922, and outside light 923.

Display control unit 921 corrects the video signal received from video signal processing circuit 913 according to the display mode or the like. The display mode can be, for example, a “cinema mode” suitable for movies, a “game mode” suitable for games, or a “normal mode”. One of these display modes is selected by the user according to the content to be displayed. Display control unit 921 corrects the video signal according to the selected display mode or the like, and transmits the corrected video signal to display unit 914. Display control unit 921 also transmits the information including the selected display mode to signal processing circuit 913.

Arithmetic circuit 915 performs the same process as arithmetic circuit 15 described with reference to FIGS. 1 and 2, and transmits the information about the details of the process to video signal processing circuit 913. The details of the process indicate the details of the signal processing shown in FIGS. 3 to 5, which is performed by intensity distribution averaging circuit 21, control signal hold circuit 22, and control signal readout circuit 23.

Optical sensor 922 detects the intensities of both the light from lighting unit 917 and outside light 923 coming into the space where display unit 914 is placed, and transmits the information corresponding to the detection result to video signal processing circuit 913.

Video signal processing circuit 913 has the function of, for example, calibrating the operation of display control unit 921. In this case, video signal processing circuit 913 calibrates the operation of display control unit 921 based on the information from display control unit 921, from optical sensor 922, and from arithmetic circuit 915. Video signal processing circuit 913 has, in addition to the function of video signal processing circuit 13 shown in FIG. 1, the function of, for example, calibrating the operation of arithmetic circuit 915. More specifically, video signal processing circuit 913 calibrates the operation of arithmetic circuit 915 based on the information from display control unit 921, from optical sensor 922, and from arithmetic circuit 915.

The structure allows calibration to be performed in consideration of outside light 923 as described above, providing sophisticated control of lighting unit 917. The structure also provides sophisticated control of display unit 914 in consideration of a combination of the signal correction by display control unit 921, outside light 923, and the details of the process of arithmetic circuit 915.

For example, when the intensity of outside light 923 is greater than a predetermined value, the control of lighting unit 917 may be ineffective or not work properly. In preparation for such a situation, video link type illuminating control system 900 can have the function of stopping the control of lighting unit 917 when optical sensor 922 detects that the intensity of outside light 923 is greater than the predetermined value.

Another video link type illuminating control system according to the third exemplary embodiment will be described as follows with reference to FIG. 10.

In FIG. 10, video link type illuminating control system 1000 includes video content 911, signal reading section 912, video signal processing circuit 913, display control unit 921, display unit 914, arithmetic circuit 915, transmission unit 916, lighting unit 917, optical sensor 922, camera 1001, and outside light 923. In video link type illuminating control system 1000 of FIG. 10, like components are labeled with like reference numerals with respect to FIG. 9, and hence the description thereof will be omitted. System 1000 of FIG. 10 differs from system 900 of FIG. 9 in having camera 1001. Therefore, the following description will be focused on camera 1001.

Camera 1001 takes a picture of a wall of the room in which video link type illuminating control system 1000 is placed, detects the color and brightness of the wall, and transmits the result to video processing circuit 915. As a result, in video link type illuminating control system 1000, arithmetic circuit 915 can perform calibration in consideration of outside light 923 and the wall condition, providing more sophisticated control of lighting unit 917 and display unit 914.

As described in the first to third exemplary embodiments, according to the present invention, the idea intended by the content creator can be fully expressed without the need to measure the average luminance or the like of the video signal displayed on display unit 14 or 914. Furthermore, the display of video on the screen of display unit 14 or 914 and the emission of light from the lighting devices can be performed at the timing intended by the content creator, so that the contents displayed on the screen and the contents of the lighting devices can agree with each other.

It is also possible to adjust the outputs of lighting units 17 and 917 according to the content being displayed on the screen of display units 14 and 914. For example, in the case of movies, the luminance level is often set low, so that setting the outputs of lighting units 17 and 917 at a low level can allow the outputs of the lighting units to be in linkage with the content.

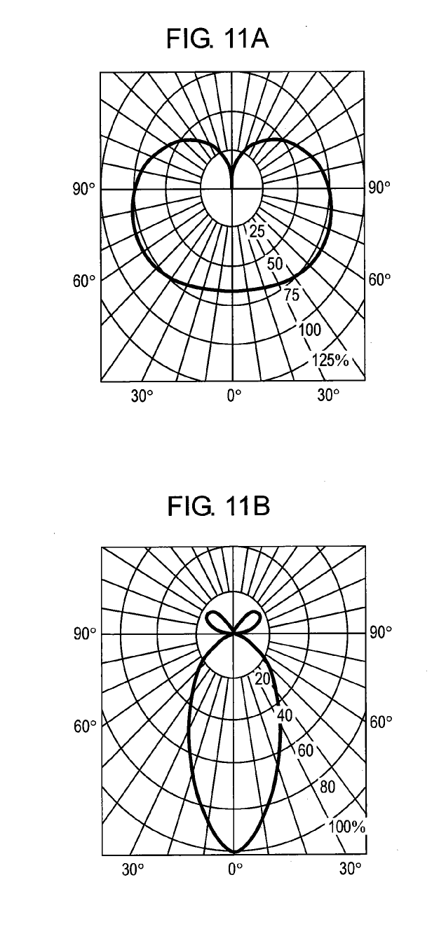

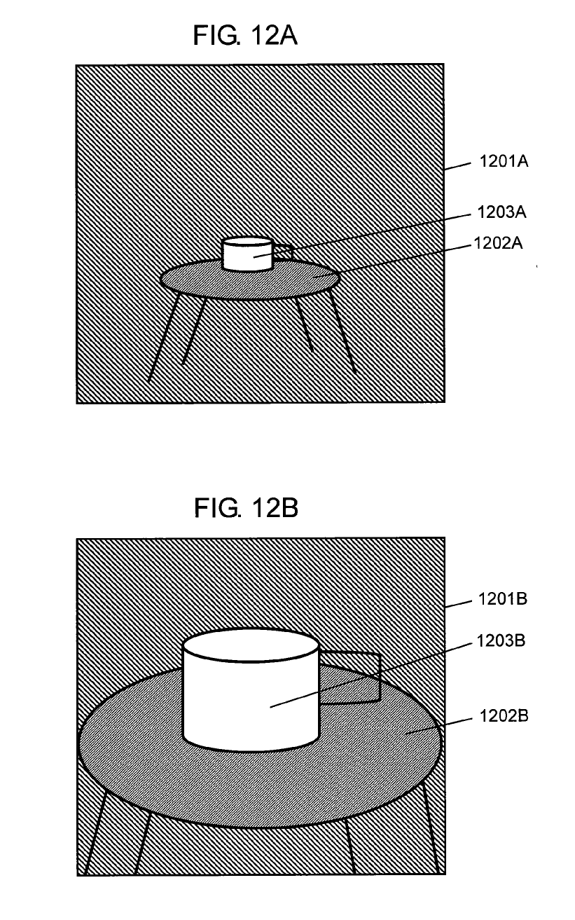

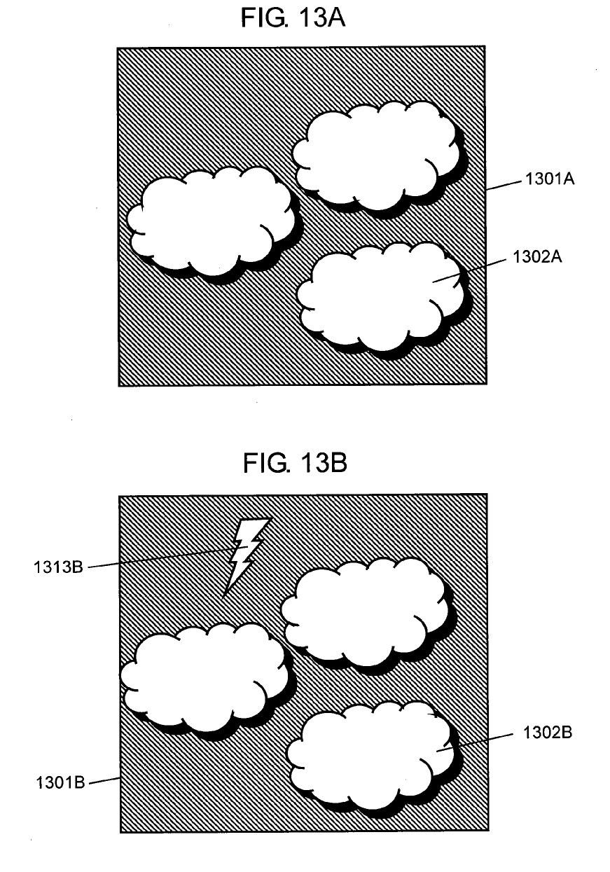

The following is a description of the directivity of the light emitted by a light emitter, a light bulb, or a lighting device used as lighting units 17 and 917 in the first to third exemplary embodiments with reference to orientation curves shown in FIGS. 11A and 11B. FIGS. 11A and 11B show the relationship between the direction of the light from the light emitter, the light bulb, or the lighting device and the intensity of the light. FIG. 11A shows an orientation curve of, for example, a compact fluorescent light bulb. A compact fluorescent light bulb produces good diffusion of light, emitting light almost uniformly in all directions. FIG. 11B shows an orientation curve of another type of light emitter or light bulb. The light emitter or light bulb emits light only in a limited direction, that is, in the direction around 0 degrees.

Therefore, considering not only the mere wattage of the light emitter, the light bulb, or the lighting device, but also the direction and spread of their light allows the lighting unit to be setup so as to reflect the idea intended by the content creator.

In the first to third exemplary embodiments, the characteristics of lighting units 17 and 917 are grasped in advance, and the optical information signal is outputted according to their characteristics, but the present invention is not limited to this. For example, it is possible to transmit the characteristics information of lighting units 17 and 917 to HDMI TV 650T or HDMI STB 600S by the visible light outputted from lighting units 17 and 917. This also allows outputting the optical information signal based on the characteristics of lighting units 17 and 917, making it unnecessary for the user to set the characteristics of lighting units 17 and 917 in advance, and hence, improving operability.

As apparent from the above description, according to of the present invention, the visual effects that the content creator wants to add to the video are recorded in advance together with video and audio in place of the position information (direction) of the light source and the intensity information of the three primary colors. The video link type illuminating control system and the video link type illuminating control method includes a circuit for reading these signals, a circuit for calculating the timing at which the lighting units emit light, and a circuit for controlling the turning on of the lighting units. The circuit for calculating the timing at which the lighting unit emit light analyses the received optical control signal, and calculates the timing at which the lighting units are made to emit light, the intensity of each color, and the timing that is synchronous with the timing at which video is displayed on the display unit. The calculation is based on the relationship between the number of the lighting units connected and their positions. The circuit for controlling the lighting units transmits signals indicating the intensities of the colors calculated by the circuit for calculating the timing of light emission to the lighting units placed around the display unit at the timing calculated by the circuit.

Thus, the present invention allows the video signal to contain information of light (color and brightness) around the viewer, making the world that is intended to be expressed by the content creator more realistic, allowing the viewer to enjoy more realism.

### INDUSTRIAL APPLICABILITY

According to the video link type illuminating control system and the video link type illuminating control method of the present invention, illumination is controlled based on the relevant information including the light effect that the video content creator intends, allowing the viewer to enjoy more realism. The video content can be a medium such as a DVD or delivered via airwaves or a network. The number and positions of the lighting units can be determined freely. Thus, the video link type illuminating control system and the video link type illuminating control method can be introduced to a variety of fields including not only households but also extensive facilities such as a movie theater.

1. A video link type illuminating control system comprising:
a signal reading section for reading an optical information signal and a video signal from a video content;
a video signal processing circuit for processing the video signal, and supplying a processed video signal to a display unit;
an arithmetic circuit for calculating a timing or an intensity of light emitted from a lighting unit based on the optical information signal, and generating an optical control signal;
the lighting unit; and
a transmission unit for transmitting the optical control signal generated by the arithmetic circuit to the lighting unit, wherein
the lighting unit receives the optical control signal from the transmission unit, and emits light in linkage with a video content displayed on the display unit.

2. The video link type illuminating control system of claim 1, further comprising:
a display control unit for correcting the video signal received from the video signal processing circuit and supplying a corrected video signal to the display unit, and also supplying information related to the corrected video signal to the video signal processing circuit;
an optical sensor for detecting at least one of the light emitted from the lighting unit and outside light, and supplying information corresponding to a detection result to the video signal processing circuit, wherein
the video signal processing circuit calibrates at least one of the arithmetic circuit and the display control unit based on at least one of the information from the display control unit and the information from the optical sensor.

3. The video link type illuminating control system of claim 2, further comprising:
a camera for taking a picture of a wall in a room that the display unit is placed, and supplying information related to the wall to the video signal processing circuit, wherein
the video signal processing circuit calibrates the arithmetic circuit based on at least one of the information from the display control unit, the information from the optical sensor, and the information from the camera.

4. The video link type illuminating control system of claim 1, wherein
the arithmetic circuit receives, from the video signal processing circuit, information about a delay time after the video signal is processed by the display unit and until the video signal is displayed, calculates the optical information signal received from the signal reading section, and outputs the control signal after holding only for a period of time corresponding to a difference between a time before the lighting unit emits light and the delay time, thereby adjusting a timing at which video is displayed on the display unit and a timing at which light is emitted from the lighting unit.

5. A video link type illuminating control method comprising:
a step for reading an optical information signal and a video signal from a video content;
a step for processing the video signal and displaying video;
a step for calculating a timing or an intensity of light emitted from an lighting unit based on the optical information signal, and generating an optical control signal;
a step for transmitting the optical control signal thus generated; and
a step for receiving the optical control signal and emitting light in linkage with the video to be displayed.

6. The video link type illuminating control system of claim 2, wherein
the arithmetic circuit receives, from the video signal processing circuit, information about a delay time after the video signal is processed by the display unit and until the video signal is displayed, calculates the optical information signal received from the signal reading section, and outputs the control signal after holding only for a period of time corresponding to a difference between a time before the lighting unit emits light and the delay time, thereby adjusting a timing at which video is displayed on the display unit and a timing at which light is emitted from the lighting unit.

7. The video link type illuminating control system of claim 3, wherein
the arithmetic circuit receives, from the video signal processing circuit, information about a delay time after the video signal is processed by the display unit and until the video signal is displayed, calculates the optical information signal received from the signal reading section, and outputs the control signal after holding only for a period of time corresponding to a difference between a time before the lighting unit emits light and the delay time, thereby adjusting a timing at which video is displayed on the display unit and a timing at which light is emitted from the lighting unit.
